(19) United States
(12) Patent Application Publication
(10) Pub. No.: US 2009/0175615 A1
(43) Pub. Date: Jul. 9, 2009

(54) LOCATION DETERMINATION METHOD

(75) Inventors: Noriyuki Kobayashi, Kawasaki (JP); Jun Arima, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/345,177

(22) Filed: Dec. 29, 2008

(30) Foreign Application Priority Data
Jan. 9, 2008 (JP) 2008-002549

(51) Int. Cl. G03B 17/24

(52) U.S. Cl. 396/310

(57) ABSTRACT

A storage medium having recorded therein a location determination program for causing a computer to execute the following steps: storing detection information including information on a detected object and the date and time on which the object was detected, and location information for that owner; determining a last detection date and time which represents the date and time on which the specified object was last detected based on the detection information; identifying an object that is owned by someone other than the owner of the object from among objects that were detected on the same date and time as the last detection date and time based on the last detection date and time as well as the detection information; and determining the location of the object based on the owner of the object.

### CROSS-REFERENCE TO RELATED APPLICATIONS

This application is based upon and the benefit of priority of Japanese Patent Application No. 2008-002549, filed on Jan. 9, 2008, the entire contents of which are incorporated herein by reference.

### TECHNICAL FIELD

The present invention relates to a location determination method for a location determination apparatus that determines the location of an object.

### BACKGROUND

In these years, various techniques for enabling belongings left behind by their owner to be located have been devised and put into practical use. For example, Japanese Patent Laid-Open No. 2005-228292 describes a technique for identifying the location of belongings by utilizing the Global Positioning System (GPS) and a technique that attaches an IC tag on belongings and utilizes a number of tag readers whose location is known.

Japanese Patent Laid-Open No. 2006-180284 discloses a camera that enables presentation of information about where a picture is taken without involving GPS-based location identification. This technique requires a user to input a schedule (contents, date and time, and location) into the camera in advance. And when a picture has been taken, a schedule corresponding to the date and time of picture taking is identified and the location included in the identified schedule is presented as the location where the picture was taken.

As outlined above, location detection of an object (e.g., a user's belongings) typically employs a method of obtaining location information by means of GPS and/or a method utilizing a fixedly installed tag reader. However, the GPS-based method has a problem of the inability to receive GPS signals indoors or underground, whereas the method using a fixedly installed tag reader is applicable only to a local area because installation of a large number of tag readers is expensive and thus only a limited number of tag readers can be installed in practice.

It is accordingly a critical issue to identify the location of an object without using reference data that enables determination of an absolute location, such as acquisition of a location by means of GPS or the position of a tag reader.

### SUMMARY

According to the present invention, there is provided a storage medium having recorded therein a location determination program for causing a computer to execute a location determination method for determining the location of an object as a search target specified by a user. The location determination program causes the computer to execute the following steps:

a storage step of, if a tag attached on an object is detected, storing detection information including information on a detected object and the date and time on which the object was detected and location information for the owner that owns the object in a storage device;

a date and time determination step of, if an object as a search target is specified by the user, determining a last detection date and time which represents the date and time on which the specified object was last detected based on the detection information;

an object identification step of identifying an object that is owned by someone other than the owner of the object as the search target from among objects that were detected on the same date and time as the last detection date and time based on the last detection date and time as well as the detection information; and

a location determination step of determining the location of the object as the search target based on the owner of the object identified at the object determination step and location information for that owner.

### BRIEF DESCRIPTION OF THE DRAWINGS

FIG. 1 illustrates an overview and features of a search system according to a first embodiment;

FIG. 2 is a functional block diagram showing the configuration of a communication apparatus;

FIG. 3 shows an example of the data structure of detection recording data;

FIG. 4 illustrates the relationship between the position of the communication apparatus and detection recording data;

FIG. 5 is a functional block diagram showing the configuration of an article search apparatus according to the embodiment;

FIG. 6 shows an example of the data structure of an article list table;

FIG. 7 shows an example of the data structure of schedule data;

FIG. 8 shows an example of the data structure of a detected object list;

FIG. 9 shows an exemplary screen on a display;

FIG. 10A is a flowchart (1) illustrating the processing procedure of the article search apparatus according to the first embodiment;

FIG. 10B is a flowchart (2) illustrating the processing procedure of the article search apparatus according to the first embodiment;

FIG. 11 shows an example of the data structure of usage history data; and

FIG. 12 shows the hardware configuration of a computer that constitutes the article search apparatus according to the first embodiment.

### DESCRIPTION OF EMBODIMENT

The location determination method according to an embodiment of the present invention is a location determination method for a location determination apparatus that, if a tag attached on an object is detected, establishes communication with a communication apparatus that records detection information including a detected object and a date and time on which the object was detected so as to determine the location of an object as a search target specified by a user. The location determination method includes: a storage step of storing the detection information and location information for an owner that owns the object in a storage device; a date and time determination step of, if an object as a search target is specified by the user, determining a last detection date and time which represents the date and time on which the specified object was last detected based on the detection information; an object identification step of identifying an object that is owned by someone other than the owner of the object as the search target from among objects that were detected on the same date and time as the last detection date and time based on the last detection date and time as well as the detection information; and a location determination step of determining the location of the object as the search target based on the owner of the object identified at the object determination step and location information for that owner.

When a search target object is specified, the location determination method determines the last detection date and time on which the search target object was detected, identifies an object that is owned by someone other than the owner of the search target object among objects that were detected on the same date and time as the last detection date and time based on the last detection date/time and detection recording data, and determines the location of the search target object based on the location information for the owner of the identified object (e.g., schedule or PC usage history information). Accordingly, it is possible to identify the location of the search target object without using reference data that enables identification of an absolute location, such as acquisition of a location by means of GPS and/or the position of a tag reader.

Also, if there are multiple objects that were detected on the same date and time as the last detection date and time, the location determination method selects an object of an owner whose location on the last detection date and time is recorded in his/her schedule from among the objects, and determines the location of the search target object based on the schedule of the owner of the selected object. It is therefore possible to identify the location of the search target object without using reference data that enables identification of an absolute location, such as acquisition of a location by means of GPS and/or the position of a tag reader.

In addition, if date and time information and location information corresponding to the last detection date and time are included in the schedule of the owner of the search target object, the location determination method determines the location of the search target object from that schedule, which thus can improve search efficiency.

Moreover, if a fixedly installed object is included in detection information that is generated according to the last detection date and time, the location determination method determines the location of the fixedly installed object as the location of the search target object. Therefore, it is possible to accurately identify the location of the search target object with a simplified processing for search.

Preferred embodiments of the location determination method according to the present invention will be described in detail below with reference to accompanying drawings.

### First Embodiment

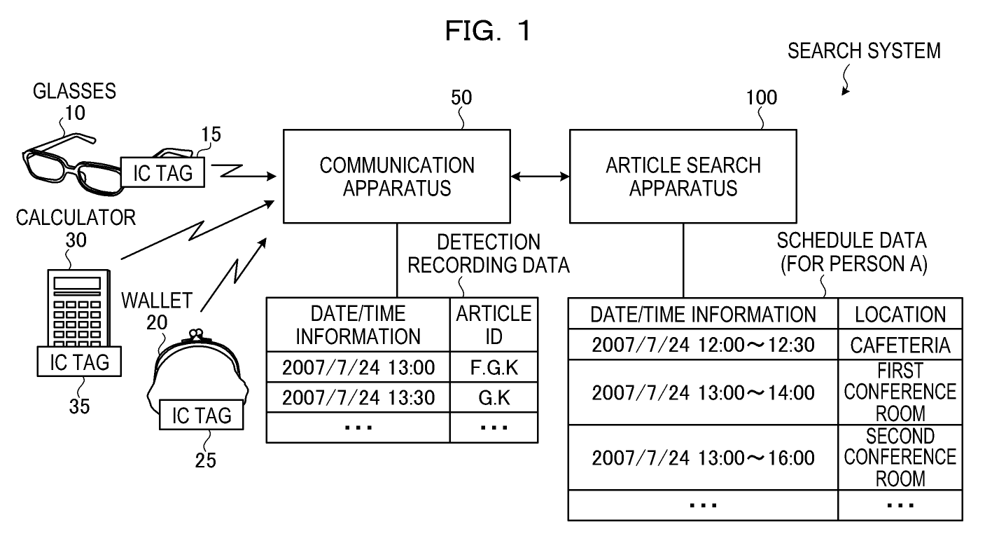

First, the overview and features of a location detecting system according to a first embodiment are described. FIG. 1 illustrates the overview and features of a search system according to the first embodiment. As shown in the figure, the search system includes a communication apparatus 50 and an article search apparatus 100.

The communication apparatus 50 detects an IC tag attached on a user's belongings (which are glasses, a calculator, and a wallet in the example shown in FIG. 1) by utilizing an Integrated Circuit (IC) tag sensor (not shown). The IC tag has recorded therein an article ID (identification) for identifying an object, and the communication apparatus 50 generates detection recording data that associates the date and time of IC tag detection with an article ID.

In the example shown in FIG. 1, assume that article ID “F” is recorded in an IC tag 15 attached on the glasses 10; article ID “G” is recorded in an IC tag 25 attached on the wallet 20; and article ID “K” is recorded in an IC tag 35 attached on the calculator 30.

The communication apparatus 50 moves by being carried by the user, for example, and registers information in detection recording data every time there is a change in detected article IDs. For example, the communication apparatus 50 initially detects article IDs “F”, “G” and “K”, and registers the detected article IDs “F”, “G” and “K” and information on the date and time of detection “1:00 p.m. on Jul. 24, 2007” in detection recording data.

If detected article IDs have changed from the article IDs “F”, “G”, and “K” to “G” and “K” (here, if article ID “F” is no longer detected), the communication apparatus 50 registers article IDs “G” and “K” as well as information on the date and time “1:30 p.m. on Jul. 24, 2007” in detection recording data. In this way, the communication apparatus 50 registers article IDs and date/time information in detection recording data every time there is a change in detected article IDs.

The article search apparatus 100 is an apparatus that establishes communication with the communication apparatus 50 to obtain detection recording data, and based on the detection recording data and on schedule data for the owner of a certain object (or belongings) determines the location of the target object. The schedule data is data that associates date/time information for the owner of an object with his/her location as shown in FIG. 1.

By way of example, when it accepts a search request for the glasses 10 having article ID “F” from the user, the article search apparatus 100 identifies the date and time on which the article ID “F” was last detected (hereinafter “last detection date and time”) based on detection recording data. In the example shown in the detection recording data of FIG. 1, the last detection date/time of article ID “F” is “1:00 p.m. on Jul. 24, 2007”.

The article search apparatus 100 then identifies article IDs “G” and “K” that were detected at the same time as article ID “F” on the last detection date and time, and identifies the owner of the object that is identified by article ID “G” or “K”. By way of example, assume here that person “A” is the owner of the article ID “G” (wallet 20), and person A is different from the owner of article ID “F” (glasses 10).

Then, the article search apparatus 100 compares the last detection date and time with the person A's schedule data, identifies a location corresponding to the last detection date and time, and informs the user of the identified location as the location of the article ID “F” (glasses 10). In the example shown in FIG. 1, since the last detection date/time “1:00 p.m. on Jul. 24, 2007” falls in person A's date/time information “1:00 to 2:00 p.m. on Jul. 24, 2007”, the article search apparatus 100 determines that the location of the glasses 10 as the search target is “the first conference room”.

In such a manner, in the search system according to the first embodiment, when an object to be searched for is specified, the article search apparatus 100 identifies the last date and time on which the specified object was last detected based on detection recording data. Based on the last detection date/time and detection recording data, the article search apparatus 100 identifies objects owned by someone other than the owner of the target object from among objects that were detected on the same date and time as the last detection date and time, and determines the location of the target object based on the schedule data for the owners of those identified objects. Accordingly, an object (i.e., belongings as the target of search) can be located without using reference data that enables identification of an absolute location, such as acquisition of a location by means of GPS or the position of a tag reader.

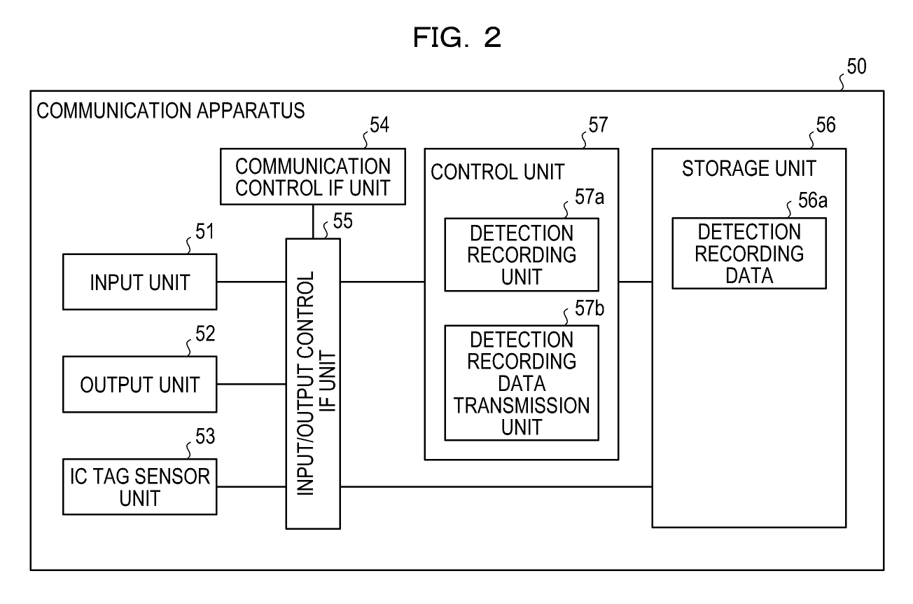

The configuration of the communication apparatus 50 shown in FIG. 1 is described next. FIG. 2 is a functional block diagram showing the configuration of the communication apparatus 50. As shown in the figure, the communication apparatus 50 includes an input unit 51, an output unit 52, an IC tag sensor unit 53, a communication control IF unit 54, an input/output control IF unit 55, a storage unit 56, and a control unit 57.

The input unit 51 is input means for inputting various types of information, composed of an entry button or the like. The output unit 52 is output means for outputting various types of information, e.g., various types of information stored in the storage unit 56, and may be a display, speaker or the like.

The IC tag sensor unit 53 is means that accesses an IC tag that is included within a communication coverage (see FIG. 1, for example) to obtain information stored in the IC tag. The communication control IF unit 54 is means for controlling communication primarily with the article search apparatus 100. The input/output control IF unit 55 is means for controlling input and output of data by the input unit 51, output unit 52, IC tag sensor unit 53, communication control IF unit 54, storage unit 56, and control unit 57.

The storage unit 56 is storage means for storing data and programs necessary for various sorts of processing performed by the control unit 57, containing detection recording data 56a as data particularly closely pertaining to the present invention, as shown in FIG. 2.

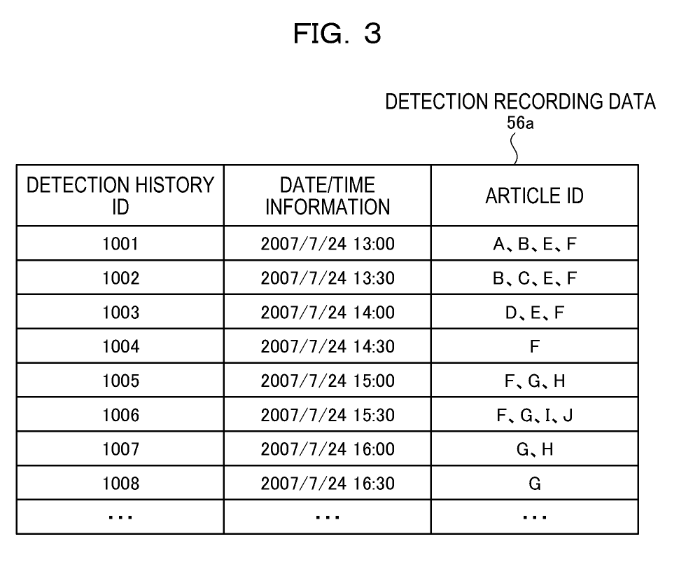

The detection recording data 56a is data on the article IDs of IC tags detected by the communication apparatus 50 and detection date/time information, as described in FIG. 1. FIG. 3 shows an example of the data structure of the detection recording data 56a. As shown in the figure, the detection recording data 56a associates a detection history ID that identifies each piece of information, date/time information, and an article ID with each other.

The control unit 57 is control means for carrying out various types of processing according to programs defining various processing procedures and/or control data, and has internal memory for storing such programs and data. The control unit 57 includes a detection recording unit 57a and a detection recording data transmission unit 57b as components particularly closely pertaining to the present invention.

The detection recording unit 57a is means for controlling the IC tag sensor unit 53 to periodically obtain article IDs from IC tags and registering detection history IDs, date/time information, and article IDs in the detection recording data 56a according to certain conditions.

Processing performed by the detection recording unit 57a will be specifically described. The detection recording unit 57a controls the IC tag sensor unit 53 to obtain an article ID recorded in an IC tag on an object, and compares the article ID with an article ID corresponding to a detection history ID that was last registered in the detection recording data 56a to determine whether the article IDs match or not.

If the article IDs do not match, the detection recording unit 57a registers the article ID obtained from the IC tag sensor unit 53, information on the date and time on which the article ID was detected, and a detection history ID in the detection recording data 56a. The detection recording unit 57a obtains date and time information from a timer not shown. If no information is stored in the detection recording data 56a (i.e., in the initial state), the detection recording unit 57a registers the article ID obtained from the IC tag sensor unit 53, information on the date and time on which the article ID was detected, and a detection history ID in the detection recording data 56a with no condition.

By way of example, we will illustrate a case where the detection recording unit 57a obtains article IDs “D”, “E”, and “F” from the IC tag sensor unit 53 when data for up to the detection history ID “1002” is stored in the detection recording data 56a shown in FIG. 3.

In this case, the detection recording unit 57a compares article IDs “B”, “C”, “E” and “F” corresponding to the detection history ID “1002” that was last registered in the detection recording data 56a with articles IDs “D”, “E” and “F” to find that the article IDs do not match. Thus, the detection recording unit 57a registers the articles IDs “D”, “E” and “F”, date/time information “2:00 p.m. on Jul. 24, 2007” on which the articles IDs “D”, “E” and “F” were detected, and a detection history ID “1003” in the detection recording data 56a.

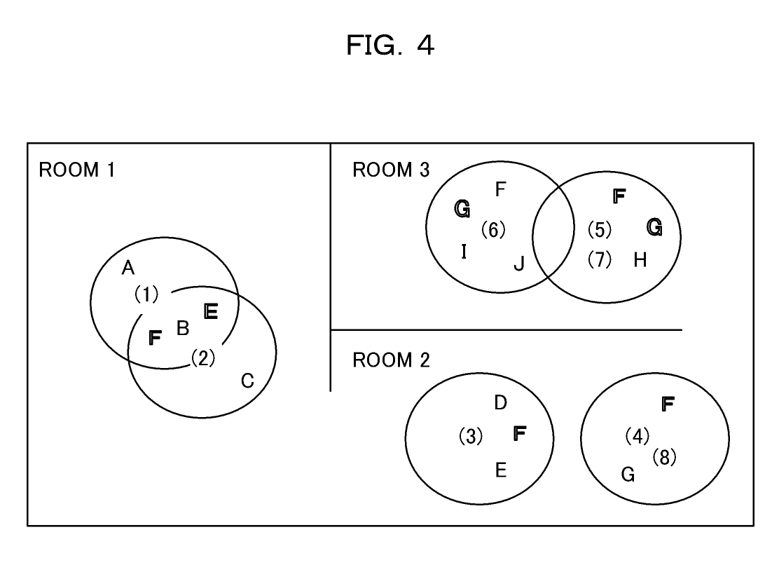

FIG. 4 illustrates the relationship between the position of the communication apparatus 50 and the detection recording data 56a. FIG. 4 assumes that the communication apparatus 50 (or the user carrying the communication apparatus 50) moves in the order of (1) to (8). Also, “A” to “H” shown in FIG. 4 represent objects on which IC tags storing corresponding article IDs “A” to “H” are attached.

More specifically, “A” represents a personal computer, “B” a book, “C” a clock, “D” a desk, “E” a wrist watch, “F” a wallet, “G” glasses, “H” the door of room 3, “I” a pen, and “J” glasses. In addition, the personal computer A, clock C, desk D, and the door H of room 3 are fixedly installed, and the other objects may move with their owner.

As shown in FIG. 4, the communication apparatus 50 (or the detection recording unit 57a, which applies to the following) detects article IDs “A”, “B”, “E”, and “F” at location (1), and registers a detection history ID “1001, date/time information “1:00 p.m. on Jul. 24, 2007”, and article IDs “A”, “B”, “E”, and “F” in the detection recording data 56a.

The communication detects article IDs “B”, “C”, “E”, and “F” at location (2) and registers a detection history ID “1002”, date/time information “1:30 p.m. on Jul. 24, 2007”, and article IDs “B”, “C”, “E”, and “F” in the detection recording data 56a.

The communication detects article IDs “D”, “E”, and “F” at location (3) and registers a detection history ID “1003”, date/time information “2:00 p.m. on Jul. 24, 2007”, and article IDs “D”, “E”, and “F” in the detection recording data 56a.

The communication detects an article ID “F” at location (4) and registers a detection history ID “1004”, date/time information “2:30 p.m. on Jul. 24, 2007”, and the article ID “F” in the detection recording data 56a.

The communication detects article IDs “F”, “G” and “H” at location (5) and registers a detection history ID “1005”, date/time information “3:00 p.m. on Jul. 24, 2007”, and article IDs “F”, “G” and “H” in the detection recording data 56a.

The communication detects article IDs “F”, “G”, “I”, and “J” at location (6) and registers a detection history ID “1006”, date/time information “3:30 p.m. on Jul. 24, 2007”, and article IDs “F”, “G”, “I”, and “J” in the detection recording data 56a.

The communication detects article IDs “G” and “H” at location (7) and registers a detection history ID “1007”, date/time information “4:00 p.m. on Jul. 24, 2007”, and article IDs “G” and “H” in the detection recording data 56a.

The communication detects an article ID “G” at location (8) and registers a detection history ID “1008”, date/time information “4:30 p.m. on Jul. 24, 2007”, and the article ID “G” in the detection recording data 56a. Thus, the detection recording data 56a shown in FIG. 3 is generated as the communication apparatus 50 moves in the order of (1) to (8).

The detection recording data transmission unit 57b is means for transmitting the detection recording data 56a stored in the storage unit 56 to the article search apparatus 100.

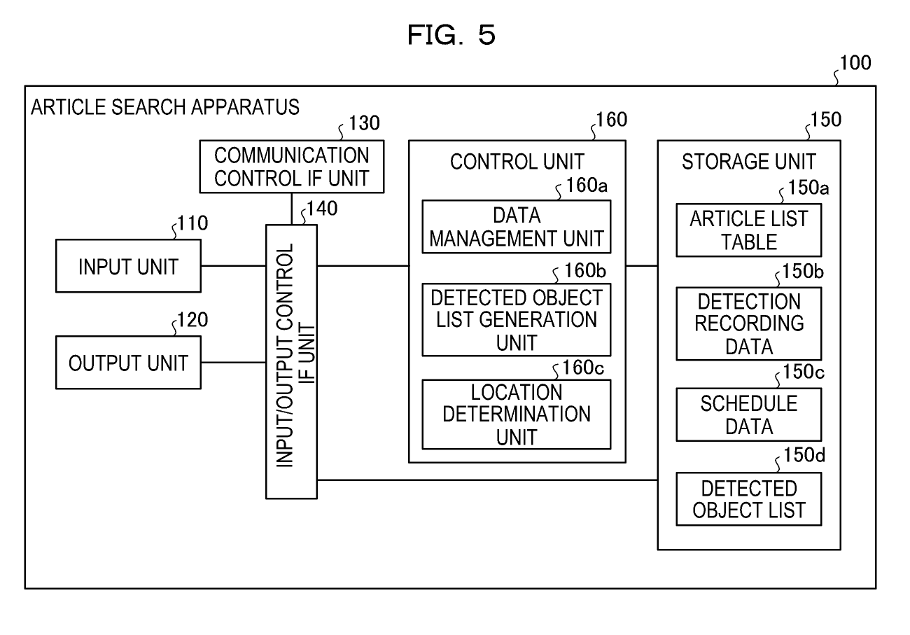

Next, the configuration of the article search apparatus 100 shown in FIG. 1 is described. FIG. 5 is a functional block diagram showing the configuration of the article search apparatus 100 according to the first embodiment. As shown in the figure, the article search apparatus 100 includes an input unit 110, an output unit 120, a communication control IF unit 130, an input/output control IF unit 140, a storage unit 150 and a control unit 160.

The input unit 110 is input means for entering various types of information and may be a keyboard, mouse, microphone, or the like. The output unit 120 is output means for outputting various types of information and displays information on a search target object, for example.

The communication control IF unit 130 is means for controlling communication primarily with the communication apparatus 50. The input/output control IF unit 140 is means for controlling input and output of data by the input unit 110, output unit 120, communication control IF unit 130, storage unit 150, and control unit 160.

The storage unit 150 is storage means for storing data and programs necessary for various sorts of processing by the control unit 160, containing an article list table 150a, detection recording data 150b, schedule data 150c, and a detected object list 150d as data particularly closely pertaining to the present invention, as shown in FIG. 5.

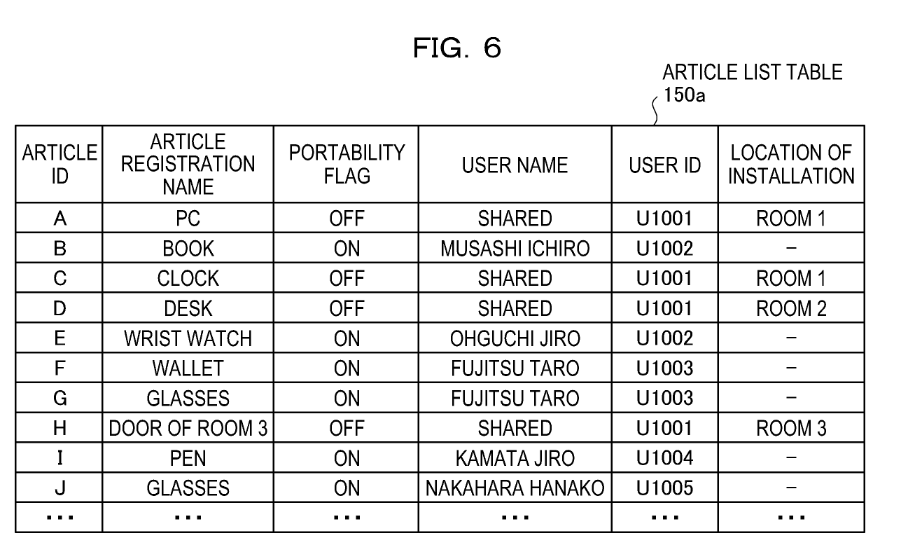

The article list table 150a stores various types of information on objects (articles) having an IC tag attached thereon. FIG. 6 shows an example of the data structure of the article list table 150a. As shown in the figure, the article list table 150a associates an article IDs, an article registration name, a portability flag, a user name, a user ID, and the location of installation with each other.

The portability flag is information that shows whether an object of interest is a fixedly installed object or a portable object (i.e., an object carried by the user). Specifically, an object for which the portability flag is “on” indicates that it is a portable object and one for which the portability flag is “off” indicates that it is a fixed object.

The user name shows the owner of the object and the user ID is information that identifies the user. The location of installation is information on the location of a fixedly installed object.

The detection recording data 150b is data on the article ID of an IC tag detected by the communication apparatus 50 and information on the date and time of detection (see FIG. 3). The detection recording data 150b is transmitted from the communication apparatus 50 to the article search apparatus 100 and stored in the storage device 150.

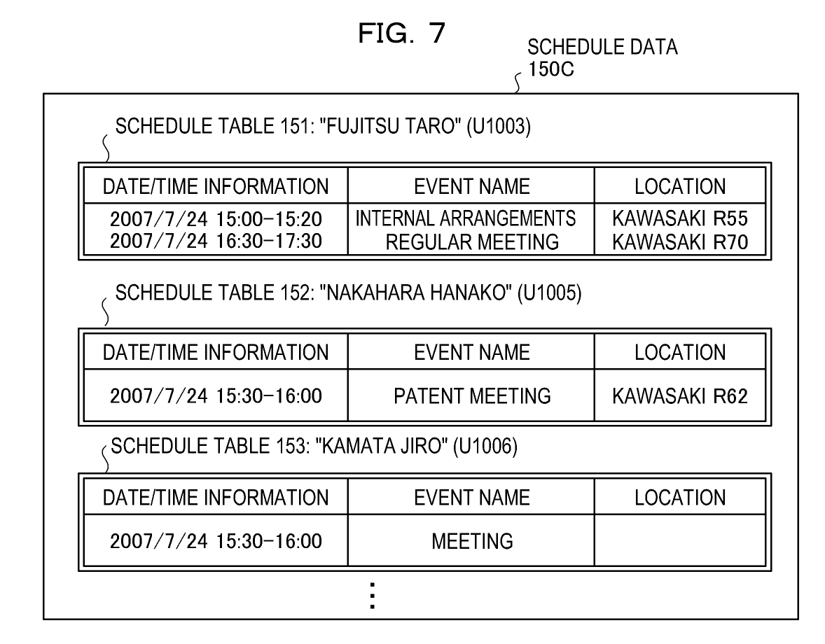

The schedule data 150c is data on the schedule of the owner of an object. FIG. 7 shows an example of the data structure of the schedule data 150c. As shown in the figure, the schedule data 150c includes a schedule table for each owner or user. For example, the schedule data 150c includes a schedule table 151 for Fujitsu Taro (user ID “U1003”), a schedule table 152 for Nakahara Hanako (user ID “U1005”), and a schedule table 153 for Kamata Jiro (user ID “1006”).

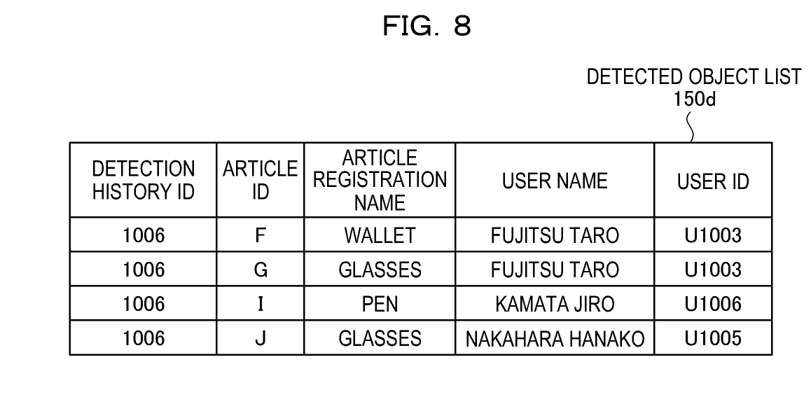

The detected object list 150d is data on various types of information on an object that was detected on the last detection date and time. FIG. 8 shows an example of the data structure of the detected object list 150d. As shown in the figure, the detected object list 150d associates a detection history ID, an article ID, an article registration name, a user name, and a user ID with each other.

The control unit 160 is control means for carrying out various types of processing according to programs defining various processing procedures and/or control data and has internal memory for storing such programs and data, including a data management unit 160a, a detected object list generation unit 160b, and a location determination unit 160c as components that particularly closely pertain to the present invention.

The data management unit 160a is means for managing the article list table 150a, detection recording data 150b, and schedule data 150c stored in the storage unit 150. For example, when it obtains update data for the article list table 150a and schedule data 150c from the input unit 110, the data management unit 160a updates the article list table 150a and schedule data 150c with the update data. When it obtains detection recording data from the communication apparatus 50, the data management unit 160a registers the detection recording data in the storage unit 150 as detection recording data 150b.

The detected object list generation unit 160b is means for generating the detected object list 150d. Specifically, when it accepts the article ID of an object as the target of search (hereinafter referred to as a “search target object”) from a user via the input unit 110, the detected object list generation unit 160b compares the article ID of the search target object with the detection recording data 150b to determine the last detection date and time.

For instance, when the article ID of the search target object is “F”, the date and time on which the article ID “F” was last detected is “3:30 p.m. on Jul. 24, 2007” from the detection recording data 150b, thus the last detection date/time is determined to be “3:30 p.m. on Jul. 24, 2007” (see FIG. 3).

The detected object list generation unit 160b then compares the last detection date/time with the detection recording data 150b to identify article IDs that correspond to the last detection date and time, and generates the detected object list 150d based on the identified article IDs and the article list table 150a. For example, when the last detection date and time is determined to be “3:30 p.m. on Jul. 24, 2007”, the corresponding article list includes “F”, “G”, “I”, and “J”, and the detected object list generation unit 160b generates the detected object list 150d shown in FIG. 8.

The location determination unit 160c is means for determining the location of the search target object based on the detected object list 150d. The location determination unit 160c executes one of a first location determination process, a second location determination process, and a third location determination process as appropriate for article IDs contained in the detected object list 150d. The order of priority among the determination processes is the first location determination process>the second location determination process>the third location determination process, for example. The first to third location determination processes are described below.

### (First Location Determination Process)

The location determination unit 160c executes the first location determination process when it compares the detected object list 150d with the article list table 150a to determine whether the article IDs in the detected object list 150d include the article IDs of fixedly installed objects or not, and it is determined that an article ID of a fixedly installed object, e.g., any one of, “A”, “C”, “D”, and “H”, is included.

The location determination unit 160c detects article IDs of fixedly installed objects included in the detected object list 150d and compares the detected article IDs with the article list table 150a so as to determine the location of the search target object. For instance, when the article ID of a fixedly installed object “A” is included in the detected object list 150d, the location of the search target object is “room 1” (see FIG. 6).

### (The Second Location Determination Process)

The location determination unit 160c attempts the second location determination process when no article ID of a fixedly installed object is included in the article IDs in the detected object list 150d. The location determination unit 160c compares the article ID of the search target object with the detected object list 150d to identify the user ID of the search target object, and compares the identified user ID with the schedule data 150c to thereby identify the schedule table for the owner of the search target object. For example, when the user ID of the search target object is “U1003”, the schedule table for the owner of the search target object is the schedule table 151.

The location determination unit 160c executes the second location determination process when comparison of the identified schedule table with the last detection date/time shows that the date/time and location corresponding to the last detection date/time are stored in that schedule table. For instance, when the schedule table for the owner of the search target object is schedule table 151, if the last detection date and time falls either in “3:00 p.m. on Jul. 24, 2007 to 3:20 p.m. on Jul. 24, 2007” or “4:30 p.m. on Jul. 24, 2007 to 5:30 p.m. on Jul. 24, 2007”, the location of the search target object can be identified.

That is, in the second location determination process, the location determination unit 160c identifies the location of the search target object by comparing the schedule table for the owner of the search target object with the last detection date and time. For example, if the schedule table for the owner of the search target object is schedule table 151 and the last detection date/time is “3:20 p.m. on Jul. 24, 2007”, the location of the search target object is “Kawasaki R55”.

### (The Third Location Determination Process)

The location determination unit 160c executes the third location determination process when it cannot identify the location of the search target object with the first or second location determination process. The location determination unit 160c first extracts article IDs other than that of the search target object (e.g., the article ID of belongings of someone who is not the searching user) from among article IDs included in the detected object list 150d.

The location determination unit 160c then compares the user ID for the extracted article ID with the schedule data 150c to extract schedule tables for the owners (persons other than the searching user), and identifies the location of the search target object from a schedule table that contains date/time information and a location corresponding to the last detection date/time from among schedule tables extracted.

For example, describing the third location determination process performed when the search target object has the article ID “F” and the last detection date/time is “3:50 p.m. on Jul. 24, 2007”, the location determination unit 160c first extracts article IDs “I” and “J” that have user IDs other than the user ID “U1003” corresponding to the article ID “F” from the detected object list 150d, and extracts schedule tables 152 and 153 that correspond to the extracted article IDs “I” and “J”.

Then, of the schedule tables 152 and 153, the location determination unit 160c uses the schedule 152 that has date/time information and a location corresponding to the last detection date/time “3:50 p.m. on Jul. 24, 2007” to identify the location of the search target object. From the schedule table 152, the location corresponding to the last detection date/time “3:50 p.m. on Jul. 24, 2007” (i.e., the location of the search target object) is determined to be “Kawasaki R62”.

In such a manner, the location determination unit 160c identifies the location of the search target object by executing any one of the first to third location determination processes and outputs information on the identified location to the output unit 120.

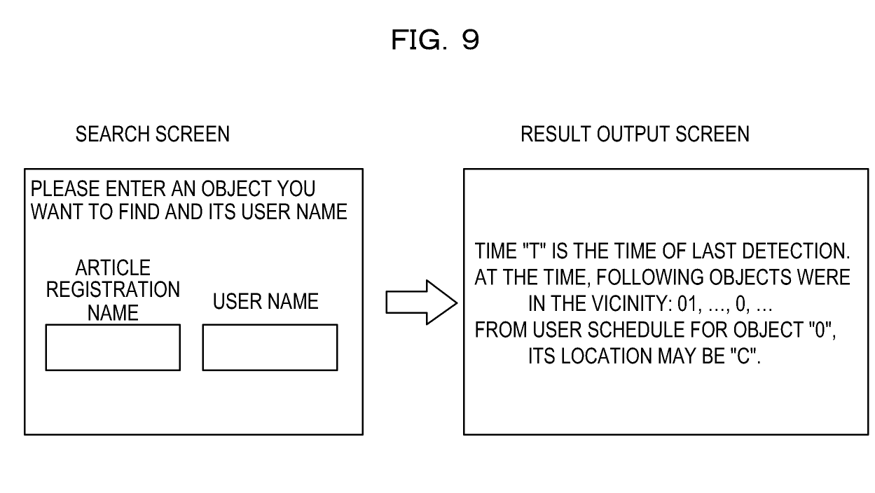

FIG. 9 shows an example of a screen on a display. The left-hand portion of FIG. 9 shows an example of a search screen and the right-hand portion shows an example of a result output screen. When the search screen is displayed, the user enters an article registration name and a user name via the input unit 110.

In this case, the detected object list generation unit 160b identifies the article ID of the search target object with the article registration name and user name as keys, identifies the last detection date/time by the above-described way, and generates the detected object list 150d.

The location determination unit 160c may also output information on the last detection date/time and detected object list 150d to the output unit 120 for display as on the result output screen shown in the right-hand portion of FIG. 9, in addition to the location of the search target object.

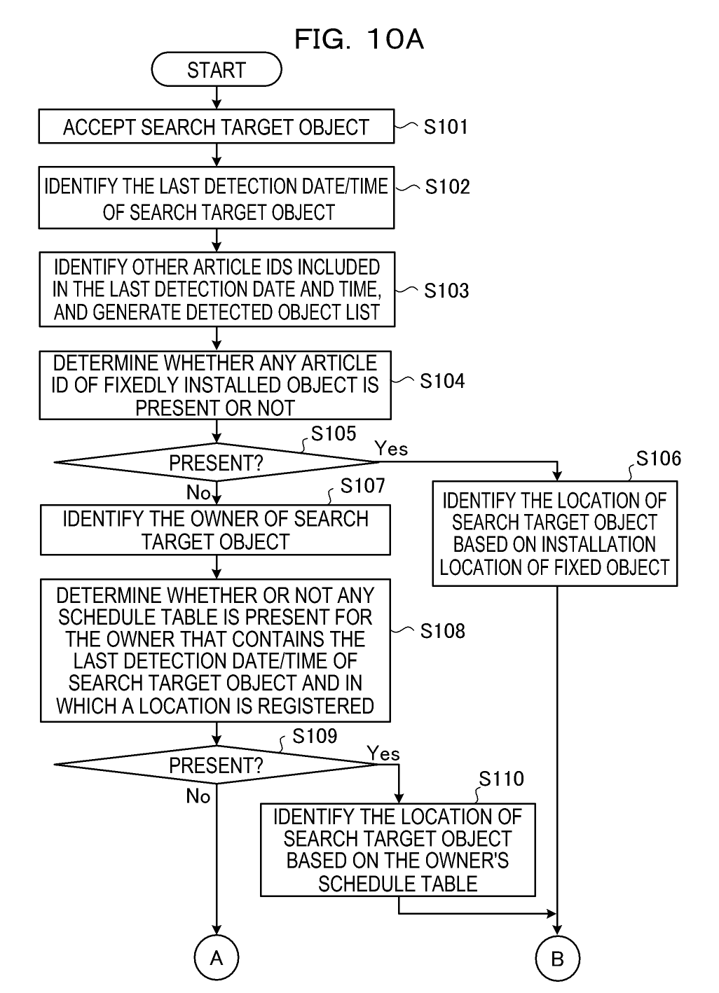

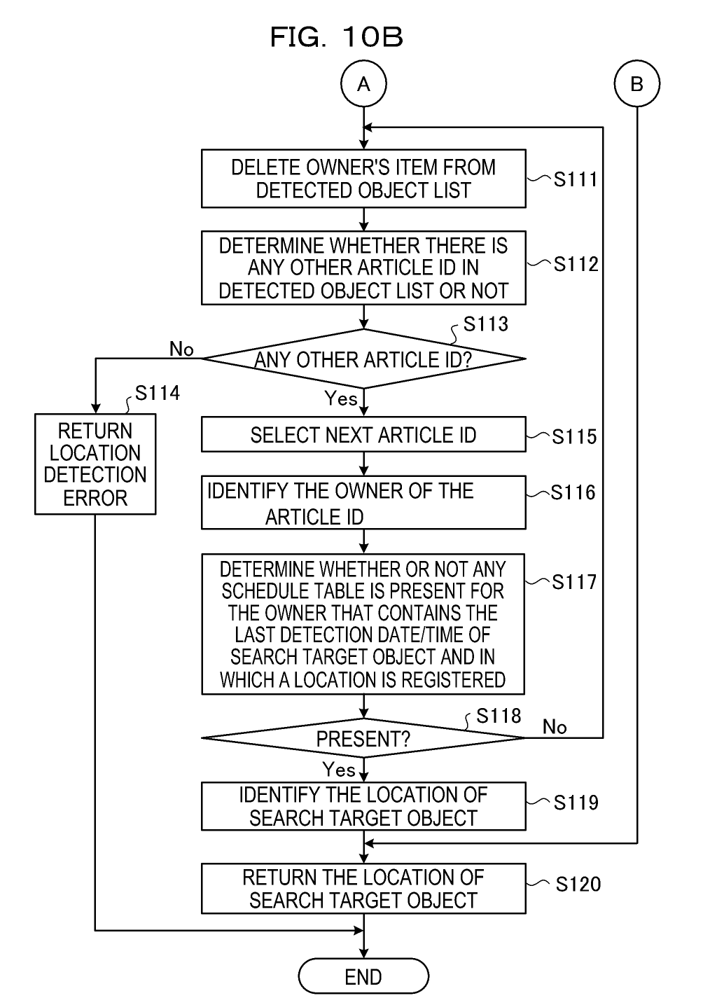

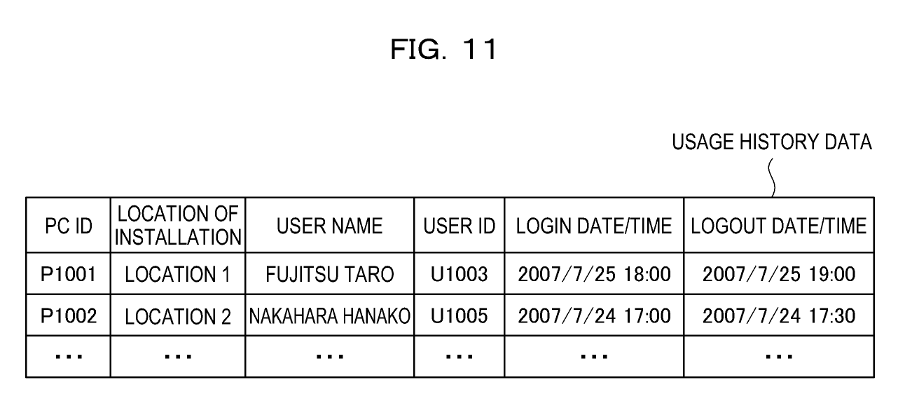

Now, the processing procedure of the article search apparatus 100 according to the first embodiment will be described. FIGS. 10 and 11 are flowcharts illustrating the processing procedure of the article search apparatus according to the first embodiment.

As shown in the figures, the article search apparatus 100 accepts the search target object (step S101), and identifies the last detection date and time of the same (step S102).

The article search apparatus 100 then identifies other article IDs included in the last detection date and time and generates the detected object list 150d (step S103), and determines whether any article ID of a fixedly installed object is present in the detected object list 150d or not (step S104).

If any article ID of a fixedly installed object is present (Yes at step S105), the article search apparatus identifies the location of the search target object based on the location where the fixed object is installed (step S106) and proceeds to step S120.

On the other hand, if no article ID of a fixedly installed object is present (No at step S105), the article search apparatus 100 identifies the owner of the search target object (step S107), and determines whether there is any schedule table for the owner that contains the last detection date and time of the search target object and in which a location is registered or not (step S108).

If there is a schedule table for the owner that contains the last detection date/time of the search target object and in which a location is registered (Yes at step S109), the article search apparatus 100 identifies the location of the search target object based on the owner's schedule table (step S110) and proceeds to step S120.

However, if there is no schedule table for the owner that satisfies the above conditions (No at step S109) the article search apparatus 100 deletes the owner's item (article ID) from the detected object list 150d (step S111), and determines whether or not any other article ID is present in the detected object list 150d (step S112).

If there is no other article ID in the detected object list 150d (No at step S113), the article search apparatus 100 returns a location detection error (step S114). On the other hand, if any other article ID is present in the detected object list 150d (Yes at step S113), the article search apparatus 100 selects the next article ID (step S115), and identifies the owner of the selected article ID (step S116).

The article search apparatus 100 then determines whether or not there is any schedule for the owner that contains the last detection date/time of the search target object and in which a location is registered (step S117). If there is any schedule for the owner that contains the last detection date/time of the search target object and in which a location is registered (Yes at step S118), the article search apparatus 100 identifies the location of the search target object (step S119), and returns the location of the search target object (step S120).

On the other hand, if there is no schedule table for the owner that satisfies the above conditions (No at step S118), the article search apparatus 100 proceeds to step S111.

As described above, when a search target object is specified, the article search apparatus 100 according to the first embodiment determines the last detection date and time on which the search target object was detected based on detection recording data, identifies an object owned by someone other than the owner of the search target object from among objects that were detected on the same date and time as the last detection date and time based on the last detection date/time and detection recording data, and identifies the location of the search target object based on a schedule table for the identified owner of the object. It is therefore possible to identify the location of the search target object without using reference data that enables identification of an absolute location, such as acquisition of a location by means of GPS or the position of a tag reader.

When a fixedly installed object is included in the detected object list 150d that is generated according to the last detection date and time, the article search apparatus 100 identifies the location of the fixedly installed object as the location of the search target object. Thus, it is possible to accurately identify the location of the search target object while simplifying the processing for search.

In addition, when date/time information and location information corresponding to the last detection date/time is included in a schedule table for the owner of the search target object, the article search apparatus 100 according to the first embodiment determines the location of the search target object from that schedule table. Therefore, efficiency of search can be improved.

### Second Embodiment

While the embodiment of the present invention has been so far described, the present invention may be practiced in various different modes other than the first embodiment described above. Thus, another embodiment embraced by the present invention will be described below as a second embodiment.

### (1) Data Utilized in Search

While the first embodiment uses the schedule data 150c to determine the location of the search target object, the present invention is not limited thereto. That is, any information other than the schedule data 150c may be utilized as long as it enables identification of a date and time and a location for each owner. For example, usage history data for a personal computer whose location of installation is already registered may be used instead of the schedule data 150c.

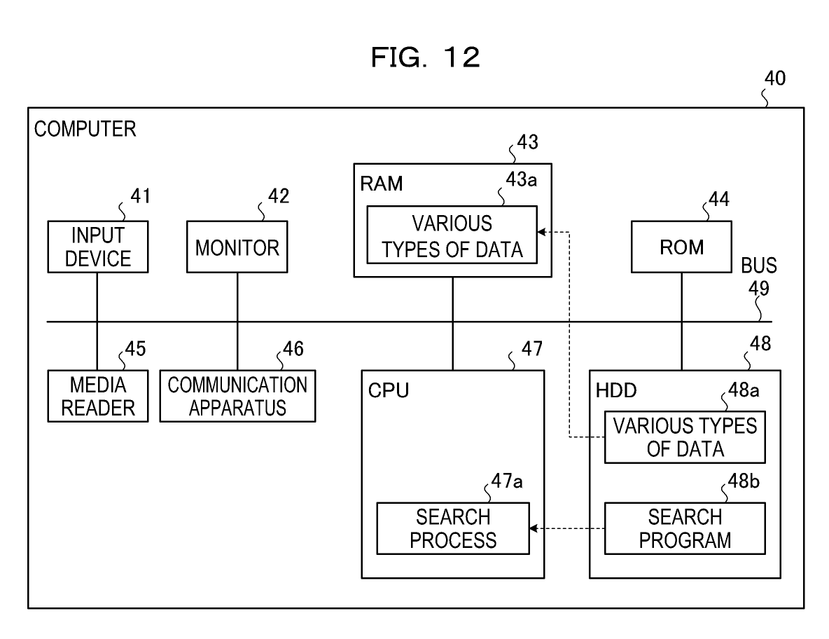

FIG. 12 shows an example of the data structure of usage history data. As shown in the figure, the usage history data includes personal computer ID, location of installation, user name, user ID, login date and time, and logout date and time. The first row of FIG. 12 shows that a personal computer having a personal computer ID “P1001” installed at “location 1” had been used by a user “Fujitsu Taro” having a user ID “U1003” from “6:00 p.m. on Jul. 25, 2007” to “7:00 p.m. on Jul. 25, 2007”.

The location determination unit 160c of the article search apparatus 100 accordingly is able to identify the location of the search target object by utilizing the usage history data in place of the schedule data 150c. For example, if the article ID for the user “Fujitsu Taro” is included in the detected object list and the last detection date/time of the search target object falls between the login date/time “6:00 p.m. on Jul. 25, 2007” to logout date/time “7:00 p.m. on Jul. 25, 2007”, the location determination unit 160c can determine that the location of the search target object is “location 1”.

### (2) System Configuration and Others

Of the processes described in the embodiment above, the entire process or some portion of the process that was described as automatically performed can also be manually done, or the entire process or some portion of it that was described as a manually performed process can also be automatically performed by a known method. In addition, change may be made as appropriate to the procedures of processing and control, specific names, information including various data and parameters that are shown in this document and the drawings unless otherwise specified.

In addition, the components of the communication apparatus 50 shown in FIG. 2 and the article search apparatus 100 shown in FIG. 5 are functionally conceptual ones and do not necessarily require to be physically configured as illustrated. That is, the specific form of distribution or integration of the apparatuses is not limited to the ones shown, but the entire apparatus or some portion thereof may be functionally or physically distributed or integrated in certain units as appropriate for various sorts of load and/or usage condition. Furthermore, the entire or an arbitrary portion of processing functions performed by the apparatuses can be realized by a CPU or a program that is parsed and executed by the CPU, or realized in hardware based on wired logic.

FIG. 12 shows a hardware configuration of a computer 40 that constitutes the article search apparatus 100 according to the first embodiment. As shown in FIG. 12, the computer (article search apparatus) 40 is composed of an input device 41, a monitor 42, Random Access Memory (RAM) 43, Read Only Memory (ROM) 44, a media reader 45 for reading data from a storage medium, a communication apparatus 46 for transmitting and receiving data to and from other devices, a Central Processing Unit (CPU) 47, and a Hard Disk Drive (HDD) 48, which are interconnected by a bus 49.

In the HDD 48, a search program 48b is stored that provides similar functions to those of the article search apparatus 100 described above. A search process 47a is activated by the CPU 47 reading and executing the search program 48b. The search process 47a corresponds to the data management unit 160a, detected object list generation unit 160b, and location determination unit 160c shown in FIG. 5.

The HDD 48 also stores various types of data 48a corresponding to the article list table 150a, detection recording data 150b, schedule data 150c, and detected object list 150d. The CPU 47 reads the various types of data 48a stored in the HDD 48 to store it in the RAM 43 and determines the location of the search target object using the various types of data 43a stored in the RAM 43.

The search program 48b shown in FIG. 12 is not necessarily stored in the HDD 48 in advance. For example, the search program 48b may be stored on a portable physical medium, such as a flexible disk (FD), CD-ROM, DVD disk, magneto-optical disk, or IC card for insertion into a computer, or on a non-removable physical medium, such as a hard disk drive (HDD) provided inside or outside of a computer, or even on other computer (or server) which is connected to the computer via a public line, the Internet, a LAN, a WAN or the like, so that the computer reads and executes the search program 48b from such a medium.

What is claimed is:

1. A location determination method for a location determination apparatus that determines the location of an object as a search target specified by a user, the location determination method comprising:
a storage step of storing detection information including information on a detected object and a date and time on which the object was detected and location information for an owner that owns the object, in a storage device;
a date and time determination step of, if an object as a search target is specified by the user, determining a last detection date and time which represents the date and time on which the specified object was last detected based on the detection information;
an object identification step of identifying an object that is owned by someone other than the owner of the object as the search target from among objects that were detected on the same date and time as the last detection date and time based on the last detection date and time as well as the detection information; and
a location determination step of determining the location of the object as the search target based on the owner of the object identified at the object determination step and location information for that owner.

2. The location determination method according to claim 1, wherein the location information for the owner which is stored in the storage device is a schedule of the owner that includes information on a date and time and information on a location.

3. The location determination method according to claim 2, wherein if the object identification step identifies a plurality of objects that were detected on the same date and time as the last detection date and time, the location determination step selects an object of an owner whose location on the last detection date and time is registered in a schedule from among the plurality of objects, and determines the location of the object as the search target based on the schedule of the owner of the selected object.

4. The location determination method according to claim 2 or 3, wherein if information on a date and time and information on a location for the owner of the object as the search target that correspond to the last detection date and time is registered in the schedule, the location determination step determines the location of the object as the search target based on the schedule of the owner of the search target object.

5. The location determination method according to any one of claims 1 to 3, wherein
the object is detected by reading a tag attached on the object; and
the object includes a fixedly installed object whose location is registered, and if the object identification step identifies a fixedly installed object among objects that were detected on the same date and time as the last detection date and time, the location determination step determines the location of the object as the search target based on the location of the fixedly installed object.

6. A location determination apparatus for determining the location of an object as a search target specified by a user, the location determination apparatus comprising:
storage means for storing detection information including information on a detected object and a date and time on which the object was detected and location information for an owner that owns the object in a storage device;
date and time determination means for, if an object as a search target is specified by the user, determining a last detection date and time which represents the date and time on which the specified object was last detected, based on the detection information stored in the storage means;
object identification means for identifying an object that is owned by someone other than the owner of the object as the search target from among objects that were detected on the same date and time as the last detection date and time based on the last detection date and time as well as the detection information; and
location determination means for determining the location of the object as the search target, based on the owner of the object identified by the object determination means and location information for that owner.

7. The location determination apparatus according to claim 6, wherein the location information for the owner is a schedule of the owner that includes information on a date and time and information on a location.

8. The location determination apparatus according to claim 7, wherein if the object identification means identifies a plurality of objects that were detected on the same date and time as the last detection date and time, the location determination means selects an object of an owner whose location on the last detection date and time is registered in a schedule from among the plurality of objects, and determines the location of the object as the search target based on the schedule of the owner of the selected object.

9. The location determination apparatus according to claim 7 or 8, wherein if information on a date and time and information on a location for the owner of the object as the search target that correspond to the last detection date and time is registered in the schedule, the location determination means determines the location of the object as the search target based on the schedule of the owner of the search target object.

10. The location determination apparatus according to any one of claims 6 to 8, wherein
the object is detected by reading a tag attached on the object; and
the object includes a fixedly installed object whose location is registered, and if the object identification means identifies a fixedly installed object among objects that were detected on the same date and time as the last detection date and time, the location determination means determines the location of the object as the search target based on the location of the fixedly installed object.
